(19) United States
(12) Patent Application Publication
(10) Pub. No.: US 2005/0048981 A1
(43) Pub. Date: Mar. 3, 2005

(54) Method and apparatus for reconnecting dropped wireless calls

(76) Inventors: Vinod Anupam, Bridgewater, NJ (US); Andre Beck, Woodbridge, NJ (US); Volker Hilt, Middletown, NJ (US); Markus Andreas Hofmann, Fair Haven, NJ (US)

Correspondence Address: Lucent Technologies Inc.;Docket Administrator (Room 3J-219), 101 Crawfords Corner Road, Holmdel, NJ, 07733-3030, US

(21) Appl. No.: 10/649,284

(22) Filed: Aug. 27, 2003

(51) Int. Cl. H04Q 7/20

(52) U.S. Cl. 455/445; 455/414.1; 455/459; 455/412.1

(57) ABSTRACT

A method and apparatus are provided such that when a wireless communication system detects that a connection to one of its subscribers has dropped, an application server within the network is dynamically called to intervene in the call and one or more options are presented to the remaining end-user of a mobile or landline terminal. The options presented to the end-user can be dependent upon whether the cause of the dropped call is one that is associated with likely having a short-term duration or is one that is associated with likely having a longer-term duration. If the cause is short term, the end-user can be given the option of being automatically reconnected to the dropped mobile terminal when it is determined to be available again. If selected by the remaining end-user, when the dropped mobile terminal is determined by the network to be available, the server sets up a call leg to it and bridges that call to the existing connection to the remaining end-user's terminal and thereafter drops out from the established connection. If the cause is determined to likely be of longer duration, the remaining end-user can be provided with various options such as being connected elsewhere or being directed to the mobile terminal end-user's voicemail.

### TECHNICAL FIELD

This invention relates to wireless communications.

### BACKGROUND OF THE INVENTION

It is not an uncommon occurrence for a call to or from a mobile terminal to be suddenly dropped mid-call as a result of a loss of signal. Typical situations in which a mobile terminal may experience a loss of signal include: leaving the coverage area of the mobile terminal end-user's service provider; entering an environment which prevents the signal from reaching the mobile terminal; and experiencing signal interference of any kind. Typically, the participants of an ongoing call that has been dropped will attempt to re-establish communication as soon as possible, i.e., as soon as the mobile terminal regains coverage. Thus, the mobile terminal end-user whose connection has been dropped must wait until he or she re-gains coverage to reattempt establishment of the call, leaving the other call participant at the other end of the dropped connection on a wireless or landline terminal to await the call back. Alternatively, the other participant has to continuously redial the phone number of the dropped mobile terminal until the call eventually gets re-established. Also, if both participants simultaneously attempt to reconnect to each other, they will both get busy signals.

### SUMMARY OF THE INVENTION

In accordance with an embodiment of the present invention, when a wireless communication system detects that a connection to one of its subscribers has dropped, an application server within the network is dynamically called to intervene in the call and one or more options are presented to the remaining end-user of a mobile or landline terminal. The options presented to the end-user can be dependent upon whether the cause of the dropped call is one that is associated with likely having a short-term duration or is one that is associated with likely having a longer-term duration. If the cause is associated with having a short-term duration, the end-user can be given the option of being automatically reconnected to the dropped mobile terminal when the mobile terminal is determined to be available again. If this option is selected by the remaining end-user, when the dropped mobile terminal is determined by the network to be available, the server sets up a call leg to it and bridges that call to the existing connection to the remaining end-user's terminal and thereafter drops out from the established connection. If the cause is one that is associated with having a longer-term duration, the remaining end-user can be provided with options such as being called back when the dropped mobile terminal is determined to be available, being redirected to another mobile terminal or landline terminal that the subscriber might have specified with the service provider, being directed to the subscriber's voicemail, or hanging up. Once the remaining end-user has made a choice and any action required to be performed by the server effects, the application server drops out.

In another embodiment of the present invention, if a calling party from either a mobile terminal or landline terminal attempts to establish a call to a wireless subscriber whose mobile terminal is determined by the wireless network to be unavailable, then the application server is called to intervene. If the cause of the unavailability is one that is likely to have a short-term duration, due to a temporary loss of signal, then the calling party can be given the option of remaining connected until the called mobile terminal is determined to be available, whereupon the application server will set up a call leg to the mobile terminal and bridge that call to the calling party's call. The application server then drops out of the connection. If the cause of the mobile terminal's unavailability is one associated with a long-term duration, then the calling party can be given the options above of being called back when the mobile terminal is determined to be available, being redirected to another mobile terminal or landline terminal that the subscriber might have specified with the service provider, being directed to the subscriber's voicemail, or hanging up.

The present invention can be applied to both voice calls and to data sessions, wherein for the latter a data session can be automatically reestablished after a temporary loss of the communication link to a wireless data terminal.

### BRIEF DESCRIPTION OF THE DRAWING

The present invention will be better understood from reading the following description of non-limiting embodiments, with reference to the attached drawing, wherein below:

FIG. 1 is a block diagram showing the architecture of a wireless communications system that incorporates the present invention;

### DETAILED DESCRIPTION

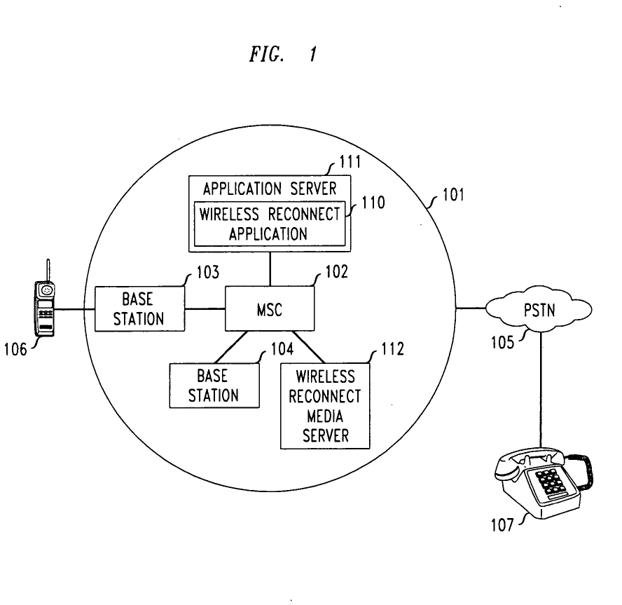

With reference to FIG. 1, a wireless communications network 101 includes a Mobile Switching Center (MSC) 102 to which a base station 103 is connected. In certain embodiments, although not shown in the figure, a Base Station Controller (BSC) may be connected between the base station 103 and the MSC 102. Other base stations, such as base station 104, are also connected to MSC 102. MSC 102, in turn, is connected to the landline Public Switched Telephone Network (PSTN) telephone network 105. An end-user whose mobile terminal 106 is within the coverage area of any base station of wireless network 101 to which he or she is a subscriber, such as base stations 103 and 104, can access wireless network 101 and can originate and receive calls to or from another wireless terminal on the same or another wireless network, or to or from a landline terminal that is connected to the PSTN 105. For illustrative purposes, a connection is assumed to exist between mobile terminal 106 through base station 103 and MSC 102 in the wireless network 101, and a landline terminal 107 that is connected to PSTN 105. It should be recognized, however, that the method described could equally be applied to a connection between mobile terminal 106 and another mobile terminal that is connected to either the same wireless network 101 to which the end-user of mobile terminal 106 subscribes or to another wireless network. Also, landline terminal 107 could communicate with mobile terminal 106 using IP telephony via an IP network (not shown) instead of PSTN 105.

As previously noted, an existing connection that has been established between mobile terminal 106 and landline terminal 107 may be suddenly dropped. Various conditions can cause the dropping of a connection. For example, an existing connection will be dropped if the battery in mobile terminal 106 suddenly goes dead. A loss of signal between the base station 103 and the mobile terminal 106 will cause the connection to be dropped. Such a loss of signal can occur if the mobile terminal 106 enters an environment that prevents a signal from reaching it, such as in a tunnel. Also, signal interference of any kind on the wireless connection between the mobile terminal 106 and the base station 103 can cause the mobile terminal to suffer a loss of signal resulting in an existing call being dropped. A dropped call could also be caused by failures between the base station 103 and MSC 102, or elsewhere within the wireless network. For example, an operation and maintenance intervention, a lack of available resources, an unspecified failure, or an ongoing network optimization procedure on the network can cause an ongoing call to be dropped.

When an existing call is dropped, the MSC 102 receives a cause code associated with the reason for the dropping. Upon detecting a dropped call, a Wireless Reconnect Application (WRA) 110 running on an application server 111 is dynamically called, with the cause code associated with the dropped call passed to it as an input. Application server 111 may be located anywhere in wireless network 101 and for purposes of illustration in FIG. 1, is shown co-located with MSC 102. When it is called from a passive state, not involved in the previous communication between wireless terminal 106 and terminal 107, WRA 110 takes control and redirects the voice stream to and from the still connected landline terminal 107 to a Wireless Reconnect Media Server (WRMS) 112 by sending out appropriate signaling messages. WRMS 112 can be located anywhere in wireless network 101 and can be the same server on which WMA 110 is running. The end-user on the remaining landline terminal 107 is then presented with an announcement that is played by WRMS 112, stating that the mobile terminal with which he or she had been communicating is currently not reachable. The WRMS 112 then audibly presents the options that may be available to that end-user. Depending on the cause code associated with the dropped call, the end-user at terminal 107 may be provided with the option of being automatically reconnected to mobile terminal 106 when it again becomes available. Thus, if the cause code indicates a loss of signal, a condition that is likely to be of short-term duration, the end-user of terminal 107 can be presented with the option to remain on the connection an automatic reconnection to mobile terminal 106 when it is available again. A short-term duration as used herein, would be the duration that an average call participant would be willing to remain on line while the call to the dropped mobile terminal is reconnected. Such duration could be determined by one skilled in the art of human factors engineering and can be assumed for purposes of example only to be approximately three minutes. If the cause code indicates a condition that is associated with having a longer-term duration, the end-user of terminal 107 may be presented with one or more options such as: to hang up on the current call and let the system attempt to reconnect to mobile terminal 106 and ring back if and when the connection to that mobile terminal is reestablished; to redirect the call to the mobile terminal user's voicemail; to redirect the call to an alternate mobile or landline terminal associated with the mobile terminal's user; and to just hang up without any reconnection attempt being made. If the end-user of terminal 107 chooses to redirect the call, the alternate number can be one registered by the mobile terminal subscriber and stored in the system in association with the identity of the subscriber's mobile terminal.

WRMS 112 awaits a response from the end-user at terminal 107, who can decide upon with which option to proceed through a touch-tone selection or by audibly responding with an appropriate word. WRMS 112 then signals the received response back to the WRA 110.

If the end-user at landline terminal 107 chooses to be reconnected, he or she is placed on hold and WRA 110 instructs WRMS 112 to play music-on-hold until a new connection to mobile terminal 106 is established or the end-user at landline terminal 107 decides to terminate the call by hanging up. A determination is then made of when mobile terminal 106 is again available. In response to signaling from WRA 110, this determination can be made by initiating polling of mobile station 106 by, for example, transmitting PAGE requests or LOCATION REPORTING CONTROL requests. If a response to such a request is received, the mobile terminal 106 is determined to be again available. Alternatively, an enhanced mobile terminal could send a message that notifies wireless network 101 when it is back online. Using either of these methods, or any other method, when the mobile terminal 106 is determined to be available again, WRA 110 initiates a connection thereto and WRMS 112 plays a voice message when the end-user there answers. If the end-user of mobile terminal 106 chooses to reconnect by affirmatively signaling verbally or through a touch-tone input, WRA 110 bridges the call leg to mobile terminal 106 with the call leg in place to the end-user at landline terminal 107. WRA 110 then enters a passive mode and drops back out of the call. If the end-user of landline terminal 107 had selected an option to be called back when mobile terminal 106 was available again, after setting up the call leg to mobile terminal 106 after it was determined to be available, WRA sets up another call leg to terminal 107. When the end-user of terminal 107 answers that call, the call leg to terminal 107 is bridged to the call leg to mobile terminal 106. Once the connection between mobile terminal 106 and landline terminal 107 is reestablished, WRA 110 enters the passive mode from which it will be dynamically called to regain control if the call drops again, but not interacting with that or any other connection otherwise.

If the end-user at landline terminal 107 had chosen a ring-back option, a timeout period may limit the time period during which WRA 110 will attempt to reconnect the call. If mobile terminal 106 does not become available within the timeout period, no attempt to reconnect the mobile terminal 106 and terminal 107 will later be made and WRA will enter the passive mode.

If the end-user of landline terminal 107 chooses the option of being connected to the mobile terminal end-user's voicemail or of terminating the call, WRA 110 frees the resources on WRMS 112 and either redirects the call to the mobile terminal end-user's voicemail or terminates the call. WRA 110 then enters the passive mode.

In the embodiment described above, it has been assumed that a call to a wireless terminal has been dropped mid-call. In another embodiment, a call attempt made to a mobile terminal 106 from either a landline terminal 107 or another mobile terminal may fail because the mobile terminal does not respond (i.e., no signal is received from the mobile terminal). If the mobile terminal 106 has been registered with the wireless network and if an attempt to actually establish the call is made, but fails due to the lack of a responding signal, MSC 102 informs WRA 110. In response, WRA 110 will decide if the loss of signal can be considered temporary or permanent. It may decide that the loss is temporary if, for example, if it has received a signal from mobile terminal 106 within a previous time interval of predetermined duration. If WRA 110 decides that the loss of signal is temporary, it proceeds as described above and connects the call to WRMS 112. WRMS 112 then plays an announcement informing the calling party at landline terminal 107 that the called party is temporarily unavailable, and offering the calling party various options. These options may include one or more of: remaining online until the called party's mobile terminal is available; hanging up on the current call and letting the system try to reconnect to mobile terminal 106 and ring back when the connection to the mobile terminal is eventually reestablished; redirecting the call to the mobile end-user's' voicemail; redirecting the call to an alternate mobile or landline phone associated with the end-user of the mobile terminal; and hanging up on the call without any reconnection attempt being made. If the loss of signal is determined to be a longer lasting or permanent one, WRA 110 does not take any action and the call is handled as usual when the called party cannot be reached (e.g., connected to the mobile terminal end-user's voicemail).

Although the above embodiments describe an automatic reconnect service for voice calls, data calls could similarly be automatically reconnected by a service provider after a temporary loss of the communication link to a wireless data terminal. For data calls, when a loss of signal to the wireless data terminal is detected, the WRA 110 is activated and automatically attempts to set up call leg to that data terminal when the terminal is determined to again be available. That call leg is then bridged to the extant connection to the data terminal at the other end of the connection and WRA then drops out and enters the passive mode.

Also, although described in conjunction with two-ended connections, the present invention could be applied in the context of conference or multi-party calls in which one or more participants is on a mobile terminal. For this situation, the reconnect service would need to be aware of the fact that the end-user is on a conference call and the entire conference should not be alerted if an end-user on a mobile terminal experiences signal loss. Instead, the service could automatically and silently re-connect the dropped mobile terminal.

Although described in conjunction with a conventional mobile network that uses any type of analog or digital technology, the automatic reconnect service could be implemented on any other type of present or future mobile network, including, for example, an all IP-based mobile network in accordance with 3GPP standards. It can also be applied in other types of wireless networks such as satellite telephony, fixed-wireless networks, VoIP over 802.11, etc.

The above described wireless reconnect service could be provided by a mobile network to every subscriber who places or receives a wireless call through it, which requires monitoring of every connection for a dropped call. Alternatively, a wireless reconnect service could be provided only to subscribers of that service.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention It is therefore contemplated that the appended claims will cover any such modifications or embodiments as fall within the true scope of the invention.

1. A method in a wireless communication network in which a first mobile terminal is adapted to communicate with another mobile or landline terminal, the method comprising:
if a wireless connection between the first mobile terminal and the network is determined to drop during an established connection between the first mobile terminal and the other terminal, automatically activating an until then passive application in the network, the application when activated performing the steps of:
if the connection between the network and the first mobile terminal is determined to be available again:
effecting the establishment of a connection to the first mobile terminal,
effecting the bridging of the connection between the first mobile terminal and the network to a connection between the network and the other terminal; and
dropping out and returning to the passive state when the connections between the mobile terminal and network and the network and the other terminal are bridged together.

2. The method of claim 1 wherein the first mobile terminal is determined to be available again if a response is received to a poll sent to the first mobile terminal.

3. The method of claim 1 wherein the first mobile terminal is determined to be available again if a signal is received from the first mobile terminal indicating that it is back online.

4. The method of claim 1 wherein a cause of the drop of the connection between the first mobile terminal and the network is provided to the application.

5. The method of claim 4 wherein if the cause of the drop is one that is not associated with having a short duration, the application effects the connection of the other terminal to be another mobile or landline terminal and then returns to the passive state.

6. The method of claim 4 wherein if the cause of the drop is one that is not associated with having a short duration, the application effects the connection of the other terminal to a voicemail of the user of the first mobile terminal and then returns to the passive state.

7. The method of claim 1 wherein the application when activated effects the transmission of a message to the other terminal that presents to an end-user at the other terminal one or more choices of actions to select from among one or more of: being rung back when the first mobile terminal becomes available again, being directed to an alternate destination, being directed to a voicemail of the end-user of the first mobile terminal, and hanging up.

8. Apparatus in a wireless communication network in which a first mobile terminal is adapted to communicate with another mobile or landline terminal, the apparatus comprising:
means for determining if a wireless connection between the first mobile terminal and the network drops during an established connection between the first mobile terminal and the other terminal;
means for determining when the connection between the network and the first mobile terminal becomes available again; and
a server running an application that is automatically activated from a passive state when the wireless connection between the first mobile terminal and the network is determined to drop, the application, when the connection between the network and the first mobile terminal is determined to be available again, effecting the establishment of a connection to the first mobile terminal, effecting the bridging of the connection between the first mobile terminal and the network to a connection between the network and the other terminal, and dropping out and returning to the passive state when the connections between the mobile terminal and network and the network and the other terminal are bridged together.

9. The apparatus of claim 8 wherein the first mobile terminal is determined to be available again when a response is received to a poll sent to the first mobile terminal.

10. The apparatus of claim 8 wherein the first mobile terminal is determined to be available again when a signal is received from the first mobile terminal indicating that it is back online.

11. The apparatus of claim 8 wherein a cause of the drop of the connection between the first mobile terminal and the network is provided to the application.

12. The apparatus of claim 11 wherein if the cause of the drop is one that is not associated with having a short duration, the application effects the connection of the other terminal to be another mobile or landline terminal.

13. The apparatus of claim 11 wherein if the cause of the drop is one that is not associated with having a short duration, the application effects the connection of the other terminal to a voicemail of the user of the first mobile terminal and then returns to the passive state.

14. The apparatus of claim 8 wherein the application when activated effects the transmission of a message to the other terminal that presents to an end-user at the other terminal one or more choices of actions to select from among one or more of: being rung back when the first mobile terminal becomes available again, being directed to an alternate destination, being directed to a voicemail of the end-user of the first mobile terminal, and hanging up.

15. A method in a wireless communication network in which a first mobile terminal is adapted to communicate with another mobile or landline terminal, the method comprising:
if an attempt to establish a call between the other terminal and the first mobile terminal fails due to a temporary loss of signal between the first mobile terminal and the network, automatically activating an until then passive application in the network, the application when activated performing the steps of:
if a connection between the network and the first mobile terminal is determined to be available again:
effecting the establishment of a connection to the first mobile terminal,
effecting the bridging of the connection between the first mobile terminal and the network to a connection between the network and the other terminal; and
dropping out and returning to the passive state when the connections between the mobile terminal and network and the network and the other terminal are bridged together.

16. The method of claim 15 further comprising determining that the loss of signal is temporary if a signal has been received from the first mobile terminal within a previous time interval of predetermined duration.

17. The method of claim 15 wherein the first mobile terminal is determined to be available again if a response is received to a poll sent to the first mobile terminal.

18. The method of claim 15 wherein the first mobile terminal is determined to be available again if a signal is received from the first mobile terminal indicating that it is back online.

19. The method of claim 15 wherein the application when activated effects the transmission of a message to the other terminal that presents to an end-user at the other terminal one or more choices of actions to select from among one or more of: being rung back when the first mobile terminal becomes available again, being directed to an alternate destination, being directed to a voicemail of the end-user of the first mobile terminal, and hanging up.
